(19) United States
(12) Patent Application Publication
(10) Pub. No.: US 2010/0299202 A1
(43) Pub. Date: Nov. 25, 2010

(54) Method And System For Pushing Advertisement To Client

(75) Inventors: Shao LI, Shenzhen City (CN); Ziguang HUANG, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/848,273

(22) Filed: Aug. 2, 2010

Related U.S. Application Data
(63) Continuation of application No. PCT/CN2009/071992, filed on May 26, 2009.

(30) Foreign Application Priority Data
Jul. 1, 2008 (CN) 200810127977.4

(51) Int. Cl. G06Q 30/00

(52) U.S. Cl. 705/14.49

(57) ABSTRACT

The embodiments of the present invention disclose a method and system for pushing an advertisement to a client. The method includes: recording characteristic information of each available advertisement position in a game; determining whether a client has accessed an advertisement position, and if the client has accessed an advertisement position, reading characteristic information of the accessed advertisement position; and selecting advertisement content matching the accessed advertisement position according to the read characteristic information, and pushing the advertisement content to the accessed advertisement position to be displayed.

### CROSS-REFERENCE TO RELATED APPLICATIONS

This application is a continuation of International Application No. PCT/CN2009/071992, filed on May 26, 2009. This application claims the benefit and priority of Chinese Application No. 200810127977.4, filed Jul. 1, 2008. The entire disclosures of each of the above applications are incorporated herein by reference.

### FIELD

The present disclosure relates to advertisement pushing technologies, and more particularly to a method and a system for pushing an advertisement to a client.

### BACKGROUND

This section provides background information related to the present disclosure which is not necessarily prior art.

In-Game Advertisements (IGAs) have become one of import income sources in a game industry. At present, a pre-integrating mode is used to push an IGA, i.e. a skilled person configures advertisement content in a certain area or an avatar of a game image, and the advertisement content is shown to a game player when the game runs. The pre-integrating mode includes two schemes. In one scheme, a game developing team integrates an advertisement into a game program when developing a game, which requires a game operator to find an advertiser and determine advertisement content before the game is developed, and requires the skilled persons to integrate the advertisement content into the game program during the game development. Therefore, in this scheme, the skilled person needs to modify the game program to integrate the advertisement content, which increases burdens of the skilled persons and costs of game development. In the other scheme, a game maintaining team modifies the game program after the game is developed to embed and replace the advertisement content, which also increases the burdens of the skilled persons and costs of game operation.

As can be seen, in the conventional pre-integrating mode, it is needed to modify the game program to embed and replace the advertisement, which increases the burdens of the skilled persons and the costs.

### SUMMARY

This section provides a general summary of the disclosure, and is not a comprehensive disclosure of its full scope or all of its features.

Embodiments of the present invention provide a method for pushing an advertisement to a client, so as to avoid modifying a game program and lighten the burdens of the skilled persons.

The technical schemes of the present invention are implemented as follows.

A method for pushing an advertisement to a client includes:

recording characteristic information of each advertisement position in a game;

determining whether a client has accessed an advertisement position, and if the client has accessed an advertisement position, reading characteristic information of the accessed advertisement position; and

selecting advertisement content matching the accessed advertisement position according to the read characteristic information, and pushing the advertisement content to the accessed advertisement position to be displayed.

The embodiments of the present invention also provide a system for pushing an advertisement to a client, by which an advertisement can be pushed to a client, and it is not needed to modify a game program, so as to lighten the burdens of the skilled persons.

A system for pushing an advertisement to a client includes: a game database, an advertisement processing module and an advertisement module; wherein

the game database is adapted to store characteristic information of each advertisement position in a game;

the advertisement processing module is adapted to determine whether a client has accessed an advertisement position, read characteristic information of the accessed advertisement position if the client has accessed the advertisement position, and send the read characteristic information to the advertisement module; receive advertisement content sent by the advertisement module, and push the received advertisement content to the accessed advertisement position to be displayed; and

the advertisement module is adapted to select advertisement content matching the accessed advertisement position according to the read characteristic information, and send the selected advertisement content to the advertisement processing module.

In view of the forgoing, in the method and system for pushing an advertisement to a client provided by the embodiments of the present invention, game data and advertisement content are independent of each other; when a game runs, according to characteristic information of an advertisement position accessed by the client, advertisement content matching the accessed advertisement position is selected, and then the selected advertisement content is pushed to the accessed advertisement position to be displayed. According to the embodiments of the present invention, it is not needed to modify the game program to embed and replace the advertisement content, which lightens the burdens of the skilled persons and decreases costs.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a general flowchart illustrating a method according to an embodiment of the present invention.

FIG. 2 is a particular flowchart illustrating a method according to an embodiment of the present invention.

FIG. 3 is a general structure diagram illustrating a system according to an embodiment of the present invention.

FIG. 4 is a particular structure diagram illustrating a system according to an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to make the object, technical schemes and merits clearer, the present invention is described hereinafter in detail with reference to the accompany drawings and embodiments.

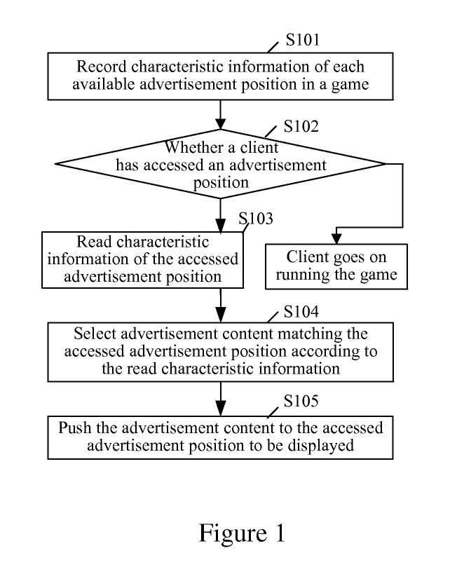

The method for pushing an advertisement to a client provided by the embodiments of the present invention is applicable to all kinds of on-line game systems. According to the method, an advertisement position accessed and characteristic information of the advertisement position can be automatically recognized, advertisement content matching the advertisement position are automatically selected according to the characteristic information of the advertisement position, and the selected advertisement content is pushed to the advertisement position to be displayed. The specific implementation of the method may refer to FIG. 1. FIG. 1 is a general flowchart illustrating a method according to an embodiment of the present invention. As shown in FIG. 1, the method includes the following steps.

Step S101: Characteristic information of each available advertisement position in a game is recorded.

Step S102: It is determined whether a client has accessed an advertisement position; if the client has accessed an advertisement position, Step S103 is performed; otherwise, the client goes on running the game.

In the method, many types of clients may be adopted, e.g. a game client, and a client that can perform game operations, which is not limited in the present invention.

In order to be convenient for description, it is taken as an example hereinafter that the client is a game client.

Step S103: Characteristic information of the accessed advertisement position is read.

Step S104: Advertisement content matching the accessed advertisement position are selected according to the read characteristic information.

Step S105: The advertisement content is pushed to the accessed advertisement position to be displayed.

As can be seen from the embodiment of the present invention, when a game is developed, it is not needed for a game developer to communicate with an advertiser to embed the advertisement content; when the game is operated, it is not needed for a game maintainer to modify game programs to embed and replace the advertisement content, thereby lightening burdens of the skilled persons and decreasing costs of game development and operation.

The foregoing simply describes the flowchart provided by the embodiments of the present invention, and the flowchart will be described hereinafter in detail with reference to specific embodiments.

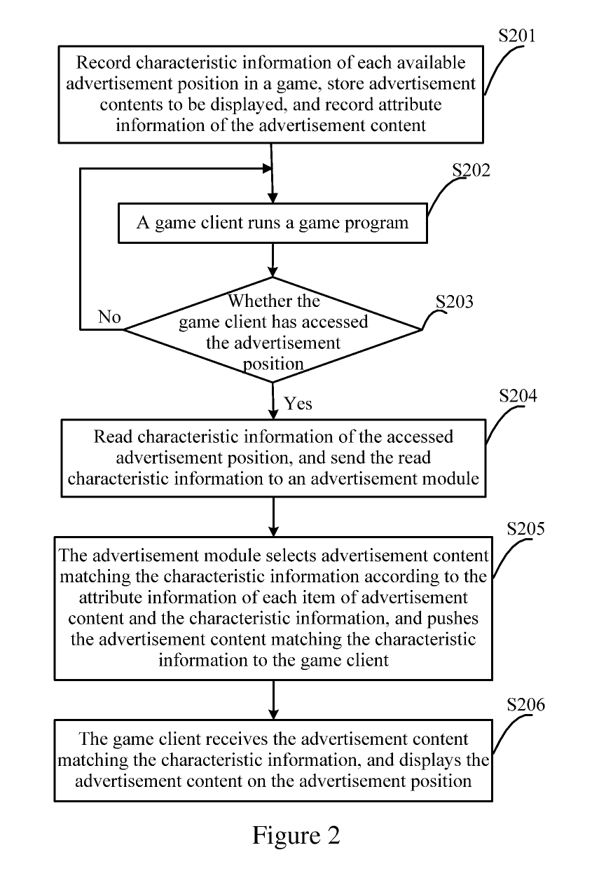

FIG. 2 is a particular flowchart illustrating a method according to an embodiment of the present invention. As shown in FIG. 2, in Step S201, characteristic information of each available advertisement position in a game is recorded, advertisement content to be displayed are stored, and attribute information of the advertisement content is recorded. In the embodiments of the present invention, the advertisement position refers to a space for displaying the advertisement content, e.g. a blank area in a game image, and an area in a virtual product or a virtual avatar in the game for displaying the advertisement content. The characteristic information of the advertisement position is used for representing characteristics of the advertisement position, and may include one characteristic item or multiple characteristic items. The characteristic information of the advertisement position may includes, but does not limit to, the size of the advertisement position, e.g. 300 pixel×200 pixel, the type of a game image associated with the advertisement position, e.g. a dynamic type, a static type, and a violent type, and so on. Similarly, the attribute information of the advertisement content is used for representing attributes of the advertisement content, and may include one attribute item or multiple attribute items. The attribute information of the advertisement content includes, but does not limit to, the size of a space occupied by the advertisement content, keywords of the advertisement content, the categories of advertisements and so on.

When playing a game, a user runs a game program through a game client, as shown in Step S202. During a procedure of playing the game by the user, it is determined whether the game client will display the advertisement position, i.e. it is determined whether the game client has accessed the advertisement position, as shown in Step S203. Here, the step of determining whether the game client has accessed the advertisement position includes determining whether the game client has accessed the advertisement position according to a current game image on the game client. How to determine whether the game client has accessed the advertisement position according to the current game image on the game client may refer to descriptions in the following embodiments 1 to 3, and will not be further described herein. In Step S203, if the game client has accessed the advertisement position, Step S204 is performed; otherwise, the game client goes on running the game.

In Step S204, the characteristic information of the accessed advertisement position is read, and the read characteristic information is sent to an advertisement module. In the embodiments of the present invention, the advertisement module may be a function module for storing and pushing the advertisement content, and may be a device independent of a game server, e.g. an advertisement server, or a function module integrated into the game server, i.e. the game server is also adapted to store and push the advertisement content.

In Step S205, the advertisement module receives the characteristic information sent by the game client, matches the characteristic information with attribute information of each item of advertisement content, selects advertisement content matching the accessed advertisement position, and pushes the advertisement content matching the accessed advertisement position to the game client. As can be seen from Step S205, the advertisement module is not only used to store and push the advertisement content in Step S204, but also used to perform matching for the advertisement content.

In Step S206, the game client receives the advertisement content matching the accessed advertisement position, and displays the advertisement content on the advertisement position. As can be seen, according to the embodiments of the present invention, the advertisement content matching the advertisement position can be automatically selected according to the characteristic information of the advertisement position, and the advertisement content can be pushed to the advertisement position, so as to improve effect of advertisement placement. Moreover, according to the embodiments of the present invention, when a game is developed, it is not needed for a game developer to communicate with an advertiser to embed the advertisement content, and when the game is operated, it is not needed for a game maintainer to modify the game program to embed and replace the advertisement content, thereby lightening the burdens of the skilled persons and decreasing the costs of game development and operation.

It should be noted that, in the above Steps S204 to S206, at least two times of network transmission are performed between the game client and the advertisement module to implement that the game client displays the advertisement content on the advertisement position. In the embodiments of the present invention, in order to save network transmission resources, the above Steps S204 to S206 may be replaced with the step of the advertisement module sending the advertisement content to be sent and attribute information of the advertisement content to the game client; here, the advertisement content to be sent may be advertisement content stored by the advertisement module in advance; or the advertisement content stored by the advertisement module in advance are divided into groups, and advertisement content in one or more groups are determined as the advertisement content to be sent according to a predefined strategy, e.g. a strategy based on using frequency of the advertisement content, which is not limited in the present invention. In this way, the game client obtains the characteristic information of the accessed advertisement position, and matches the characteristic information with the attribute information of the advertisement content, selects the advertisement content matching the accessed advertisement position, and thus displays the advertisement content matching the accessed advertisement position on the advertisement position. As can be seen, the game client may display the advertisement content on the advertisement position if only one time of network transmission is performed between the game client and the advertisement module, thereby greatly saving the network resources.

The implementation of the present invention will be further described hereinafter with reference to specific embodiments.

### Embodiment 1

This embodiment relates to a method for pushing advertisement content to a game client in an on-line game system. The on-line game system includes at least one game server and several game clients, and the advertisement content is stored in an advertisement server which is equivalent with the above advertisement module. In this embodiment, a game image includes static content and dynamic content. The static content refers to fixed and changeless content, and is often presented at an edge or corner of a window of the game client, or is presented in a background image. The dynamic content refers to variable content, is often presented at the inner of the window of the game client, and changes with the interaction between a game user and the game server. When a game is developed, the static content is integrated into the game client, and the dynamic content is stored in the game server. Correspondingly, advertisement positions are configured in the static content and the dynamic content, and identifiers (IDs) are used to differentiate different advertisement positions, i.e. the ID corresponding to each advertisement position is identity information of the advertisement position. In this way, the characteristic information of each advertisement position may be recorded according to the ID of the advertisement position. In this embodiment, the characteristic information of the advertisement position is recorded and stored by using a structure format as shown in Table 1.

TABLE 1
storage format of characteristic information
of an advertisement position

| | | | | |
|---|---|---|---|---|
| ID of advertisement | characteristic | characteristic | . . . | characteristic |
| position | item 1 | item 2 | | item n |

Similarly, different advertisement content may be differentiated through IDs of the advertisement content, and the attribute information of the advertisement content is recorded and stored according to the IDs of the advertisement content. In this embodiment, the attribute information of the advertisement content is shown in Table 2.

TABLE 2
storage format of attribute information of advertisement content

| | | | | |
|---|---|---|---|---|
| ID of advertisement | attribute | attribute | . . . | attribute |
| content | item 1 | item 2 | | item n |

As can be seen from Table 2, one item of advertisement content may correspond to multiple attribute items.

When a game runs, the IDs of the advertisement positions and the advertisement positions are transmitted together. In this way, the game client may determine whether the game client has accessed the advertisement position by determining whether the read static content contains the ID of the advertisement position, and determine whether the game client has accessed the advertisement position by determining whether the received dynamic content contains the ID of the advertisement position.

After the game client has accessed the advertisement position, the game client reads the characteristic information of the accessed advertisement position or the advertisement position to be displayed, and sends the read characteristic information to the advertisement server. As mentioned above, the game image includes the static content and the dynamic content; the characteristic information of the advertisement position in the static content may be integrated into the static content, i.e. integrated in the game client, or be stored in the game server. The characteristic information of the advertisement position in the dynamic content is generally stored in the game server. If the characteristic information of the advertisement position is integrated in the game client, the game client can read the characteristic information of the advertisement position without interacting with the game server. If the characteristic information of the advertisement position is stored in the game server, in one scheme, the characteristic information of the advertisement position is transmitted together with the advertisement position or game data, so the game client may read the characteristic information of the advertisement position from the local without interacting with the game server, and thus burdens of the game server are decreased and the speed of pushing the advertisement is increased. In another scheme, the characteristic information of the advertisement position and game data, e.g. dynamic content are respectively transmitted; specifically, when reading the ID of the advertisement position, the game client requests the game server to send characteristic information corresponding to the ID of the advertisement position. The scheme has the following advantages: the game data and the characteristic information of the advertisement position are not transmitted simultaneously, so as to lighten the burdens of network bandwidth, ensure the real-time operation of the game, and avoid the pause problem of the game. The skilled person in the art should understand, the characteristic information of the advertisement position may be read in other modes, which is still in the principle and the protection scope of the present invention.

And then, the advertisement server receives the characteristic information sent by the game client, and matches the characteristic information with the attribute information of each item of the advertisement content. As shown in Tables 1 and 2, in the embodiment, the characteristic information of the advertisement position and the attribute information of the advertisement content are recorded by using a structure format, so as to conveniently match the advertisement content with the advertisement position. Specifically, when matching a certain item of advertisement content with the advertisement position, the advertisement server respectively matches an attribute item 1 of the advertisement content with a characteristic item 1 of the advertisement position, an attribute item 2 of the advertisement content with a characteristic item 2 of the advertisement position, an attribute item 3 of the advertisement content with a characteristic item 3 of the advertisement position and so on, to obtain multiple matching factors. The advertisement server selects advertisement content matching the accessed advertisement position according to the multiple matching factors, e.g. selects advertisement content best matching the advertisement position, and pushes the advertisement content matching the accessed advertisement position to the game client. Afterwards, the game client receives the advertisement content, and displays the advertisement content on the advertisement position.

### Embodiment 2

The procedure described in the embodiment 2 is the same as that described in the embodiment 1, the difference between them is that in the embodiment 2 a label is adopted to identify a category of advertisement positions, and the characteristic information of each advertisement position is stored and transmitted together with the advertisement position. Correspondingly, a recording format of the characteristic information of the advertisement position is as follows.

TABLE 3
storage format of characteristic information
of an advertisement position

| | | | |
|---|---|---|---|
| characteristic | Characteristic | . . . | characteristic |
| item 1 | item 2 | | item n |

Similarly, the attribute information of the advertisement content is also stored by using a structure format, referring to the above Table 2.

In the embodiment, the game client determines whether the game client has accessed an advertisement position by determining whether the read static content contains the label of the advertisement position, and determine whether the game client has accessed an advertisement position by determining whether the received dynamic content contains the label of the advertisement position. Since the characteristic information of the advertisement position is transmitted together with the advertisement position, so if the game client has accessed the advertisement position, the game client may instantly obtain the characteristic information of the advertisement position without interacting with the game server, thereby decreasing the burdens of the game server and increasing the speed of pushing advertisements. Afterwards, the game client sends the characteristic information of the advertisement position to the game server, and the subsequent procedure is the same as that in the embodiment 1, and will not be described in detail.

The scheme of the embodiment 2 has the following advantages: a uniform label is used to represent multiple advertisement positions, and it is not needed to configure one ID for each advertisement position, and not needed to store and transmit the ID of each advertisement position, so that system resources are saved; in addition, it can be determined whether the game client has accessed the advertisement position according to the uniform label, so that the burdens of the game client are decreased; and the game client does not need to interact with the game server when the game client has accessed the advertisement position, so that the burdens of the game server, the game client and the network environment are decreased.

### Embodiment 3

The embodiment 3 is an improvement of the embodiments 1 and 2. In the above embodiments 1 and 2, the game client is adapted to determine whether the read static content contains the advertisement position and whether the received dynamic content contains the advertisement position. In the embodiment 3, the game client is only adapted to determine whether the static content read from the local contains the advertisement position, specifically to determine whether the read static content contains identity information of the advertisement position; the identity information may be the ID of the advertisement position in the embodiment 1 or the label of the advertisement position in the embodiment 2, which is not limited in this embodiment. The game server is adapted to determine whether the dynamic content sent to the game client contains the advertisement position, e.g. determine according to the ID of the advertisement position or the label of the advertisement position, and inform the game client when determining that the dynamic content contains the advertisement position.

As can be seen from the embodiment 3, the game client only needs to determine whether the static content read from the local contains the advertisement position, thereby greatly decreasing the burdens of the game client, avoiding the game pause resulted by that too many system recourses of the game client are occupied, and improve experiences of game players.

The skilled person in the art should understand that, after the game server informs the game client that the dynamic content contains the advertisement position, the game client may read the characteristic information of the advertisement position and send the characteristic information of the advertisement position, or the game server may read the characteristic information of the advertisement position and send the characteristic information of the advertisement position to the advertisement server.

The foregoing has described the main steps of the method for pushing an advertisement to a game client with reference to the accompanying drawings and embodiments, especially described the steps of recording the characteristic information of the advertisement position and the attribute information of the advertisement content, and determining whether the game client has accessed the advertisement position. The matching step will be described in detail hereinafter.

In an embodiment, the characteristic information of the advertisement position includes the size of the advertisement position, and the attribute information of the advertisement content includes the size of a space occupied by the advertisement content. After receiving the characteristic information of the advertisement position, e.g. receiving the characteristic information from the game client or from the game server, the advertisement server calculates a matching degree between each item of the advertisement content and the advertisement position according to the size of the advertisement position and the size of the space occupied by the advertisement content, and pushes the advertisement content best matching the advertisement position to the game client to be displayed. In order to obtain the advertisement content best matching the advertisement position, the advertisement server may sequence the matching degrees between all items of advertisement content and the advertisement position, or adopt other methods for finding a maximum value in the art, e.g. a pairwise comparing method.

As an improved scheme, the advertisement server first selects the advertisement content by which the size of the space occupied is less than or equal to the size of the advertisement position, and then selects the advertisement content best matching the advertisement position from the selected items of the advertisement content. The improved scheme can avoid that the pushed advertisement content exceeds the scope of the advertisement position.

As another improved scheme, the advertisement server sequences the items of the advertisement content according to the matching degrees, divides the items of the advertisement content into several categories, and then randomly or conditionally selects one item of advertisement content from a category best matching the advertisement position to be displayed. The improved scheme can increase the pushing probability of each item of advertisement content and avoid that one or several items of the advertisement content are pushed for too many times.

In another embodiment, the attribute information of the advertisement content includes several attribute items A1˜An, and the characteristic information of the advertisement position includes several characteristic items B1˜Bn. In this case, after receiving the characteristic information sent by the game client, the advertisement server calculates the matching degree between each item of the advertisement content and the advertisement position.

Step 1: the advertisement server calculates the matching degree between an attribute item A1 of the advertisement content and a characteristic item B1 of the advertisement position, takes the matching degree as a matching factor R1, calculates the matching degree between an attribute item A2 of the advertisement content and a characteristic item B2 of the advertisement position, takes the matching degree as a matching factor R2, the rest may be deduced by analogy, to obtain n matching factors R1˜Rn.

Step 2: the advertisement server selects the advertisement content best matching the advertisement position according to n matching factors R1˜Rn.

In Step 2, the advertisement server may calculate the sum of the n matching factors and select the advertisement content best matching the advertisement position according to the obtained sum; or first weighs the n matching factors, then calculates the sum of the n matching factors and finally selects the advertisement content best matching the advertisement position according to the obtained sum. Similarly, as another improved scheme, the advertisement server divides the items of the advertisement content into several categories according the matching degrees, and selects an item of the advertisement content from a category best matching the advertisement position to be displayed.

In another embodiment, the attribute items of the advertisement content include the size of a space occupied by the advertisement content, a content keyword and an advertisement category. The content keyword is related to the advertisement content, involved products and services, and the advertisement category represents the category of involved products or services, e.g. sport equipment, foodstuff, leisure equipment, financing services and so on. The characteristic items of the advertisement position include the size of the advertisement position, game content associated with the advertisement position, and a game category. Similarly, the game content is related to the topic, characters and scenarios of the game, and the game category is adapted to identify the type of the games, e.g. violence type, an intelligence type, a leisure type and so on. In this case, in Step S205, the advertisement server calculates a matching degree between the size of the space occupied by the advertisement content and the size of the advertisement position, takes the matching degree as a first matching factor, calculates a matching degree between the content keyword and the game content, takes the matching degree as a second matching factor, calculates a matching degree between the advertisement category, the game type and takes the matching degree as a third matching factor, calculates a sum of the three matching factors, or calculates a sum of the three matching factors after weighing the three matching factors, and selects the advertisement content to be pushed according to the sum.

As an improved scheme, the attribute items of the advertisement content may also include a color type adopted by the advertisement content, e.g. warm colors including red, yellow and so on, or cold colors including gray, bronze and so on, a desired sound effect and so on, and the characteristic items of the advertisement position may also include a game scene color related to the advertisement position, a game sound effect related to the advertisement position, and so on. Correspondingly, the advertisement server also calculates a matching degree between the color type and the game scene color, takes the matching degree as a matching factor, calculates a matching degree between the desired sound effect and the game sound effect, and takes the matching degree as another matching factor.

It should be noted that, the number of the attribute items of the advertisement content may be more than or less than the number of the characteristic items of the advertisement position. In this case, the advertisement server may perform matching by using a weighing mode or a predefined value. For example, if a certain item of advertisement content is not sensitive to the game scene color of the game scene, the advertisement server may calculate the matching degree between the advertisement content and the game scene color by using a predefined value, e.g. a maximum value 1, 80 percent of the maximum value 1, 50 percent of the maximum value 1 and so on.

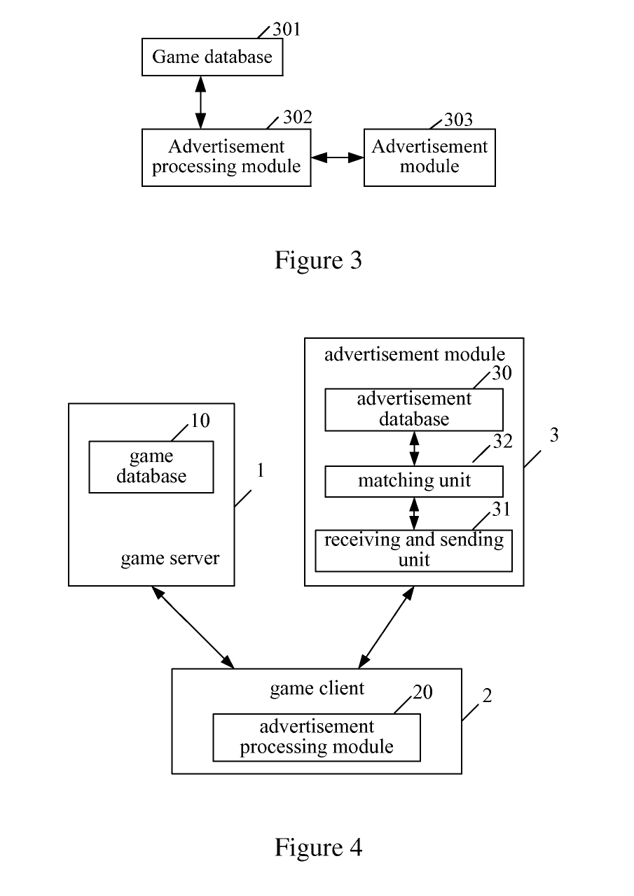

FIG. 3 is a general structure diagram illustrating a system for pushing an advertisement according to an embodiment of the present invention. As shown in FIG. 3, the system includes a game database 301, an advertisement processing module 302 and an advertisement module 303.

The advertisement database 301 is adapted to store characteristic information of each available advertisement position in a game.

The advertisement processing module 302 is adapted to determine whether a game client has accessed an advertisement position, read characteristic information of the accessed advertisement position if the client has accessed the advertisement position, and send the read characteristic information to the advertisement module 303; receive advertisement content sent by the advertisement module 303, and push the received advertisement content to the accessed advertisement position to be displayed.

The advertisement module 303 is adapted to select advertisement content matching the accessed advertisement position according to the read characteristic information, and send the selected advertisement content to the advertisement processing module 302.

In order to make the embodiment clearer, the system provided by the embodiment will be described hereinafter in detail.

Referring to FIG. 4, FIG. 4 is a particular structure diagram illustrating a system according to an embodiment of the present invention. As shown in FIG. 4, the system includes a game server 1, a game client 2 and an advertisement module 3, and the game server 1 is connected with the game client 2 to constitute an on-line game system.

Preferably, as shown in FIG. 4, the system further includes a game database 10, and the game database 10 may be independent of the game server 1 or be configured in the game server 1, which is not limited in the embodiments of the present invention. Preferably, in FIG. 4, the game database 10 is configured in the game server 1.

The game database 10 stores game information, e.g. a game program, user information, user interaction information and so on. In addition, the game database 10 stores characteristic information of each available advertisement position in the game.

Preferably, as shown in FIG. 4, the system further includes an advertisement processing module 20, and the advertisement processing module 20 may be configured in the game client 2, or be independent of the game client 2, which is not limited in the embodiments of the present invention. In FIG. 4, the advertisement processing module 20 is configured in the game client 2.

The advertisement processing module 20 is adapted to determine whether the game client 2 has accessed an advertisement position, specifically, the advertisement processing module 20 determines whether the game client 2 has accessed an advertisement position according to a current game image of the game client 2; the advertisement processing module 20 is adapted to read characteristic information of the accessed advertisement position if the game client 2 has accessed the advertisement position, and send the read characteristic information to the advertisement module 3; receive advertisement content sent by the advertisement module 3, and push the received advertisement content to the accessed advertisement position to be displayed.

The foregoing has described, with reference to FIG. 2, how to determine whether the game client 2 has accessed the advertisement position and how to read the characteristic information of the advertisement position when the advertisement position has been accessed. For example, the game server 1 may synchronously send game data and the characteristic information of the advertisement positions related to the game data, in this case, the advertisement processing module 20 may read the characteristic information of the advertisement position without interacting with the game server 1; the game server 1 may also send the game data firstly, and then send the characteristic information of the advertisement position when the game client 2 requests the game server 1 to send the characteristic information of the advertisement position.

The advertisement module 3 is adapted to select advertisement content matching the accessed advertisement position according to the received characteristic information, and send the selected advertisement content to the advertisement processing module 20.

Preferably, as shown in FIG. 4, the system further includes an advertisement database 30 adapted to store advertisement content to be displayed and attribute information of the advertisement content. The advertisement database 30 may be configured in the advertisement module 3, or be independent of the advertisement module 3. In FIG. 4, the advertisement database 30 is configured in the advertisement module 3.

As shown in FIG. 4, the advertisement module 3 includes a receiving and sending unit 31 and a matching unit 32.

The receiving and sending unit 31 is adapted to receive the characteristic information sent by the advertisement processing module 20.

The matching unit 32 is connected with the receiving and sending unit 31 and the advertisement database 30, and is adapted to select the advertisement content matching the accessed advertisement position according to the characteristic information received by the receiving and sending unit 31 and the attribute information of the advertisement content stored by the advertisement database 30, and send the selected advertisement content to the advertisement processing module 20 through the receiving and sending unit 31.

Preferably, the attribute information of the advertisement content stored by the advertisement database 30 includes attribute items A1˜An, and the characteristic information of the advertisement position read by the advertisement processing module 20 includes characteristic items B1˜Bn.

In this way, the matching unit 32 calculates matching degrees between attribute items A1˜An of each item of recorded advertisement content and the characteristic items B1˜Bn of the accessed advertisement position to obtain matching factors R1˜Rn, calculates a sum of the matching factors R1˜Rn, and takes the sum as a matching degree between the advertisement content and the accessed advertisement position; or calculates a sum of the matching factors R1˜Rn after weighing the matching factors R1˜Rn, and takes the sum as a matching degree between the advertisement content and the accessed advertisement position; finally, selects the advertisement content matching the accessed advertisement position according to the calculated matching degrees between each item of advertisement content and the accessed advertisement position.

Preferably, the characteristic information of the advertisement position read by the advertisement processing module 20 includes the size of the advertisement position, and the attribute information of the advertisement content stored by the advertisement database 30 includes the size of a space occupied by the advertisement content,

the matching unit 32 calculates a matching degree between each item of advertisement content recorded by the advertisement database 30 and the accessed advertisement position according to the size of the space occupied by the advertisement content and the size of the read advertisement position, and selects the advertisement content matching the accessed advertisement position according to the obtained the matching degree between each item of advertisement content and the accessed advertisement position; or

selects the sizes of the spaces which are smaller than or equal to the size of the advertisement position from recorded sizes of the spaces occupied by the advertisement content, selects the size of the space closest to the size of the advertisement position from the selected sizes of the spaces, and takes the advertisement content corresponding to the selected size of the space closest to the size of the advertisement position as the advertisement content matching the accessed advertisement position.

It should be noted that with reference to Step S205, the foregoing has described the specific procedure of selecting the advertisement content matching the advertisement position, which will not be described in detail.

The advertisement module 3 may be a host or a host cluster independent of the game server 1, or a function module with the same functions integrated into the game server 1. If the advertisement module 3 and the game server 1 are integrated, the advertisement module 3 may directly read the characteristic information of the advertisement position from the game server 1, which is still in the protection scope of the claims of the present invention.

In view of the foregoing, compared with the conventional method for pushing an advertisement to a client, in the method and system for pushing an advertisement to a client provided by the embodiments of the present invention, the game data and the advertisement content is independent of each other; when a game runs, according to the characteristic information of the advertisement position accessed by the client, the advertisement content matching the accessed advertisement position are selected, and then the selected advertisement content is pushed to the accessed advertisement position to be displayed. According to the embodiments of the present invention, it is not needed to modify the game program to embed and replace the advertisement content, thereby lightening the burdens of the skilled persons and decreasing costs.

The foregoing are only preferred embodiments of the present invention and are not for use in limiting the protection scope thereof. Any modification, equivalent replacement and improvement made under the spirit and principle of the present invention should be included in the protection scope thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for pushing an advertisement to a client, comprising:
recording characteristic information of each advertisement position in a game;
determining whether a client has accessed an advertisement position, and if the client has accessed an advertisement position, reading characteristic information of the accessed advertisement position; and
selecting advertisement content matching the accessed advertisement position according to the read characteristic information, and pushing the advertisement content to the accessed advertisement position to be displayed.

2. The method of claim 1, further comprising: recording the advertisement content and attribute information of the advertisement content; wherein
selecting advertisement content matching the accessed advertisement position according to the read characteristic information comprises:
selecting the advertisement content matching the accessed advertisement position according to the read characteristic information and the attribute information of the advertisement content.

3. The method of claim 2, wherein the attribute information of the advertisement content comprises attribute items A1˜An;
the read characteristic information of the advertisement position comprises characteristic items B1˜Bn;
selecting the advertisement content matching the accessed advertisement position comprises:
calculating matching degrees between the attribute items A1˜An of each item of the advertisement content recorded and the characteristic items B1˜Bn of the accessed advertisement position to obtain matching factors R1˜Rn, calculating a sum of the matching factors R1˜Rn, and taking the sum as a matching degree between the advertisement content and the accessed advertisement position; or calculating a sum of the matching factors R1˜Rn after weighing the matching factors R1˜Rn, and taking the sum as a matching degree between the advertisement content and the accessed advertisement position;
selecting the advertisement content matching the accessed advertisement position according to the matching degree between each item of the advertisement content recorded and the accessed advertisement position.

4. The method of claim 3, wherein the attribute items of the advertisement content comprises attribute items respectively corresponding to the size of a space occupied by the advertisement content, a content keyword and an advertisement category; the characteristic items of the advertisement position comprises characteristic items respectively corresponding to the size of the advertisement position, game content associated with the advertisement position and a game type;
the matching factors comprises matching factors respectively corresponding to a matching degree between the size of the space occupied by the advertisement content and the size of the advertisement position, a matching degree between the content keyword and the game content, and a matching degree between the advertisement category and the game type.

5. The method of claim 2, wherein the read characteristic information of the advertisement position comprises the size of the advertisement position, and the attribute information of the advertisement content comprises the size of a space occupied by the advertisement content;
selecting the advertisement content matching the accessed advertisement position comprises:
calculating a matching degree between each item of the advertisement content recorded and the accessed advertisement position according to the size of the space occupied by the advertisement content and the size of the read advertisement position, and selecting the advertisement content matching the accessed advertisement position according to the obtained matching degree between each item of the advertisement content recorded and the accessed advertisement position; or
selecting the sizes of spaces each of which is smaller than or equal to the size of the advertisement position from recorded sizes of the spaces occupied by the advertisement content, selecting the size of the space closest to the size of the advertisement position from the selected sizes of spaces, and taking advertisement content corresponding to the selected size of the space closest to the size of the advertisement position as the advertisement content matching the accessed advertisement position.

6. The method of claim 4, wherein selecting the advertisement content matching the accessed advertisement position according to the matching degree comprises:
sequencing the matching degrees between the items of the advertisement content and the accessed advertisement position, selecting advertisement content best matching the accessed advertisement position, and taking the selected advertisement content best matching the accessed advertisement position as the advertisement content matching to the accessed advertisement position.

7. The method of claim 5, wherein selecting the advertisement content matching the accessed advertisement position according to the matching degree comprises:
sequencing the matching degrees between the items of the advertisement content and the accessed advertisement position, selecting advertisement content best matching the accessed advertisement position, and taking the selected advertisement content best matching the accessed advertisement position as the advertisement content matching to the accessed advertisement position.

8. The method of claim 4, wherein selecting the advertisement content matching the accessed advertisement position according to the matching degree comprises:
sequencing the matching degrees between the items of the advertisement content and the accessed advertisement position, divides the items of the advertisement content into multiple categories according to a result of the sequencing, selecting one item of advertisement content from a category best matching the accessed advertisement position, and taking the selected advertisement content as the advertisement content matching to the accessed advertisement position.

9. The method of claim 5, wherein selecting the advertisement content matching the accessed advertisement position according to the matching degree comprises:
sequencing the matching degrees between the items of the advertisement content and the accessed advertisement position, divides the items of the advertisement content into multiple categories according to a result of the sequencing, selecting one item of advertisement content from a category best matching the accessed advertisement position, and taking the selected advertisement content as the advertisement content matching to the accessed advertisement position.

10. The method of claim 1, wherein determining whether the client has accessed an advertisement position comprises:
determining whether the client has accessed the advertisement position according to a current game image.

11. The method of claim 10, wherein the game image comprises identity information of the advertisement position;
determining whether the client has accessed the advertisement position according to a current game image comprises:
determining whether the current game image comprises the identity information of the advertisement position; if the current game image comprises the identity information of the advertisement position, determining that the client has accessed the advertisement position; if the current game image do not comprise the identity information of the advertisement position, determining that the client has not accessed the advertisement position.

12. The method of claim 11, wherein the identity information of the advertisement position is an identifier (ID) of the advertisement position, or a predefined label of the advertisement position.

13. The method of claim 11, wherein the current game image comprises static content and dynamic content, the static content is stored in the client and the dynamic content is stored in a game server;
determining whether the current game image comprises the identity information of the advertisement position comprises:
determining, by the client, whether the static content currently read comprises the identity information of the advertisement position; if the static content currently read comprises the identity information of the advertisement position, determining that the static content of the current game image comprises the identity information of the advertisement position; if the static content currently read does not comprise the identity information of the advertisement position, determining that the static content of the current game image does not comprise the identity information of the advertisement position; and
determining, by the game server, whether the dynamic content sent to the client comprises the identity information of the advertisement position, and sending a determining result to the client;
determining, by the client, that the dynamic content of the current game image comprises the identity information of the advertisement position if the determining result indicates that the dynamic content comprises the identity information of the advertisement position; and determining that the dynamic content of the current game image does not comprise the identity information of the advertisement position if the determining result indicates that the dynamic content does not comprise the identity information of the advertisement position.

14. A system for pushing an advertisement to a client, comprising a game database, an advertisement processing module and an advertisement module; wherein
the game database is adapted to store characteristic information of each advertisement position in a game;
the advertisement processing module is adapted to determine whether a client has accessed an advertisement position, read characteristic information of the accessed advertisement position if the client has accessed the advertisement position, and send the read characteristic information to the advertisement module; receive advertisement content sent by the advertisement module, and push the received advertisement content to the accessed advertisement position to be displayed; and
the advertisement module is adapted to select advertisement content matching the accessed advertisement position according to the read characteristic information, and send the selected advertisement content to the advertisement processing module.

15. The system of claim 14, further comprising an advertisement database; wherein
the advertisement database is adapted to store the advertisement content and attribute information of the advertisement content;
the advertisement module comprises a receiving and sending unit and a matching unit;
the receiving and sending unit is adapted to receive the characteristic information sent by the advertisement processing module;
the matching unit is adapted to select the advertisement content matching the accessed advertisement position according to the characteristic information received by the receiving and sending unit and the attribute information of the advertisement content stored by the advertisement database, and send the selected advertisement content to the advertisement processing module through the receiving and sending unit.

16. The system of claim 15, wherein the attribute information of the advertisement content stored by the advertisement database comprises attribute items A1˜An;
the characteristic information of the advertisement position read by the advertisement processing module comprises characteristic items B1˜Bn;
the matching unit is adapted to calculate matching degrees between the attribute items A1˜An of each item of the advertisement content recorded and the characteristic items B1˜Bn of the accessed advertisement position to obtain matching factors R1˜Rn, calculate a sum of the matching factors R1˜Rn, and take the sum as a matching degree between the advertisement content and the accessed advertisement position; or calculate a sum of the matching factors R1˜Rn after weighing the matching factors R1˜Rn, and take the sum as a matching degree between the advertisement content and the accessed advertisement position.

17. The system of claim 15, wherein the characteristic information of the advertisement position read by the advertisement processing module comprises the size of the advertisement position, and the attribute information of the advertisement content comprises the size of a space occupied by the advertisement content;
the matching unit is adapted to calculate a matching degree between each item of the advertisement content and the accessed advertisement position according to the size of the space occupied by the advertisement content and the size of the read advertisement position, and select the advertisement content matching the accessed advertisement position according to the matching degree between each item of the advertisement content and the accessed advertisement position; or
select the sizes of spaces each of which are smaller than or equal to the size of the advertisement position from recorded sizes of the spaces occupied by the advertisement content, select the size of space closest to the size of the advertisement position from the selected sizes of spaces, and take advertisement content corresponding to the selected size of the space closest to the size of the advertisement position as the advertisement content matching the accessed advertisement position.

18. The system of claim 14, wherein the advertisement processing module is adapted to determine whether the client has accessed the advertisement position according to a current game image.
